(19) United States
(12) Patent Application Publication
(10) Pub. No.: US 2011/0153460 A1
(43) Pub. Date: Jun. 23, 2011

(54) SINGLE WINDOW BASED E-COMMERCE BUSINESS TRANSACTION

(76) Inventor: Allen Keith Watts, Sanford, FL (US)

(21) Appl. No.: 12/640,177

(22) Filed: Dec. 17, 2009

(51) Int. Cl. G06Q 30/00; G06Q 50/00

(52) U.S. Cl. 705/27.1; 705/26.1

(57) ABSTRACT

The present invention relates to a single window e commerce based transaction where an end user can access multiple automobile parts dealers' product catalogue by accessing a single webpage, and making purchases online without bothering to physically visit each dealer's location and checking his inventory for the desired product.

### CROSS-REFERENCE TO RELATED APPLICATIONS

Not Applicable

### STATEMENT REGARDING FEDERALLY SPONSORED RESEARCH OR DEVELOPMENT

Not Applicable

### Reference to Sequence Listing, a Table, or a Computer Program Listing Compact Disc Appendix

Not Applicable

### TECHNICAL FIELD OF THE INVENTION

The present invention relates to an e commerce based business transaction. More specifically, it relates to a method and system to facilitate an ecommerce transaction through a single window made available online to a plurality of sellers.

### BACKGROUND OF THE INVENTION

Recent advancements in Information Technology have largely re-defined the way conventional shopping was accomplished. The modern day buyer does not need to physically check in at the shops to purchase item(s) of his choice. The online tools available have also given the buyer the option to chose from a range of products, coming from different manufacturers, and then to select the one(s) he need to buy and make purchase accordingly. Such online tools have been popularized in the market through players like Amazon.com and Ebay.com.

While various hostings like http://www.ebay.com, http://www.lavictoriaparts.com/ have been quite successful for products like books and gift items, for a certain category of products, like automobile parts and accessories, it is imperative for a customer to get the product of the right make and through the right dealers authorized to sell the desired product. This routinely involves the task of individually locating and connecting to such dealer, enquire about the suitable product and then get the entire sell process executed. In case, the desired product is not available at that dealer, the whole process needs to be re-done again.

Therefore there is a need to develop such method and system to allow a customer to remotely connect to multiple dealers selling the same class/make of products and purchase the product using available online methods irrespective of what is available in the dealer's real-time inventory. Such method and system of online purchase must also allow the dealers to put their product catalogue in a web-format of their choice and shipping and other logistics arrangements to their convenience.

### BRIEF SUMMARY OF THE INVENTION

The present invention offers a one-stop solution for customers looking, particularly, for automobile parts and accessories. The method and system of the present invention provides a hosting between dedicated automobile parts dealers and their prospective customers. In this Business-to-Consumer methodology, at the customer hosting, an option to choose the vehicle of particular make and model is provided which directs the customer to a dedicated dealers' list offering the parts and accessories for the said make and model. Hyperlinks are provided at against each dealer's name which directs the customer to the dealers' dedicated homepage wherein the customer can select and make an online purchase of the product, whether or not the dealer's inventory supports it, since if the dealer does not have that product in his inventory, he can order it.

### BRIEF DESCRIPTION OF THE DRAWING

Preferred embodiments of the invention are described herein below with reference to the drawings wherein:

FIG. 1 illustrates a screen shot of a hosting webpage according to an embodiment of the present invention.

FIG. 2 illustrates a screen shot of a dealer's list webpage according to an embodiment of the present invention.

FIG. 3 illustrates a screen shot of a dealer's webpage according to an embodiment of the present invention.

FIG. 4 illustrates a screen shot of a product catalogue webpage according to an embodiment of the present invention.

FIG. 5 illustrates a screen shot of a specific product webpage according to an embodiment of the present invention.

FIG. 6 illustrates a screen shot of a ‘shopping cart’ webpage according to an embodiment of the present invention.

FIG. 7 is a flowchart diagram for an exemplary representation of the complete business transaction as achieved through an embodiment of the present invention.

FIG. 8 is a schematic illustration of an e-commerce based transaction system according to an embodiment of the present invention.

### DETAILED DESCRIPTION OF THE INVENTION

In one embodiment of the invention, a prospective customer (hereinafter also referred to as end user), who intends to look for or buy a desired automobile part(s) or accessories, first logs onto the hosting webpage 100 to select from a list of available automobile ‘makes’ and models, his make and model of choice through the selection means. Once such a choice is done, the end user is directed to a dealers' list webpage 200 having a list of dealers who are authorized to sell the parts and accessories of the selected automobile make and model. Herein, on selecting any particular dealer, the end user is directed to a dedicated webpage 300 of that dealer detailing his product catalogue i.e. retrieved seller data 308 and contact details, etc retrieved from the data storage means 806 by the data retrieval means 808. The dealer homepage 300 is hosted on the same internet webpage 100. The end user can select his product of choice from the product catalogue add all such product(s) selected in the ‘shopping cart’ provided at the homepage through order taking means 810. The products are finally purchased through payment means 812 using the payment gateways option available on the said dealers' homepage.

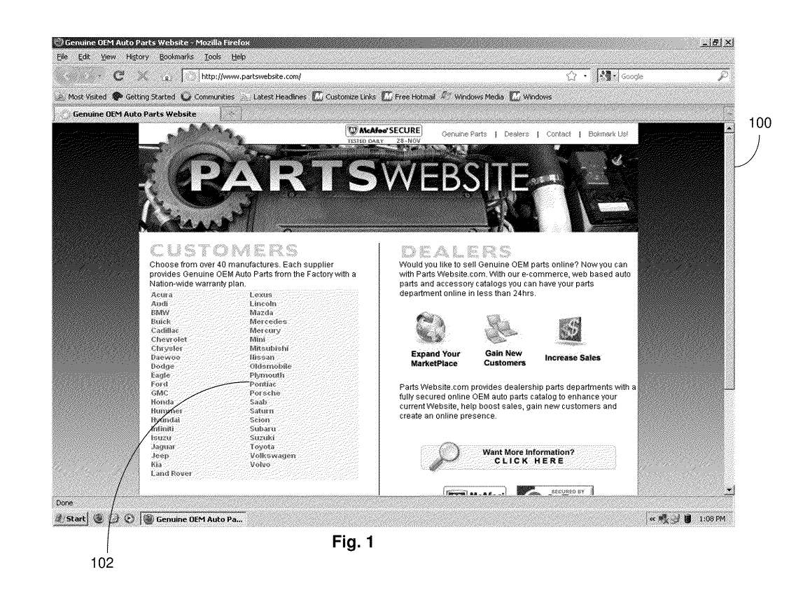

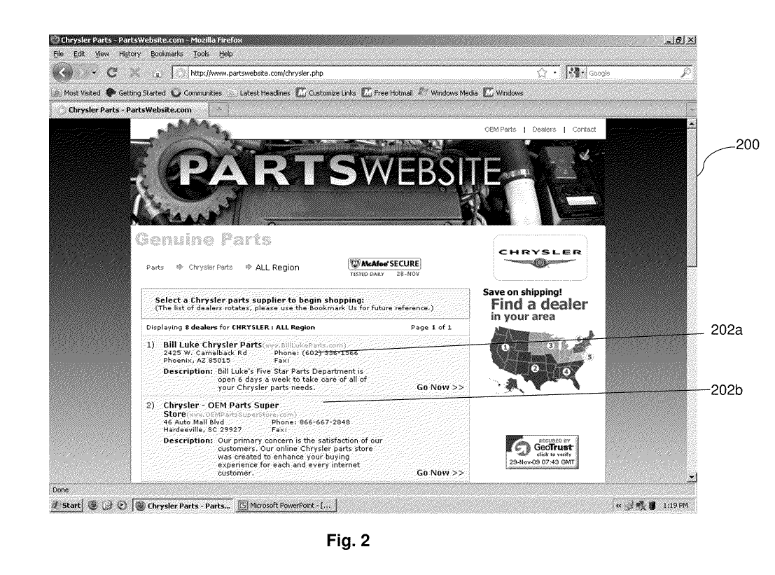

In one aspect of the present invention, the hosting webpage 100 allows an end user to simultaneously access the product catalogues of dealers physically located at remote locations. In an embodiment of the invention, the webpage 100 could be accessed through an end-user hosting means including, for example, a computer terminal, a mobile phone or the like which offer such a hosting to establish an internet communication network. In yet another embodiment of the invention, the webpage 100 contain a predefined dealer database wherein the dealer data is segregated primarily on the basis of a particular automobile make for which the dealers are authorized to sell the parts or accessories, though, other basis of segregation too can be designed and implemented. The database 716 is created and stored in a data storage means 806 associated with the webpage 100. The data storage means is configured to store parts data as obtained through an automotive publication offering both Mechanical and Collision OEM parts data 720. The accessories data 722, in contrast, comes from the respective dealers. The data so obtained from the respective sources are further classified and maintained as catalogs 718 by the webpage 100. As shown in FIG. 1, on the webpage 100, an end user can browse through a list of automobile brands present at interface 102. The webpage 100 maintain a catalogue of parts and accessories data for each automobile brand as shown at interface 102. In an embodiment of the invention, an end user has the option to click on his hyperlink available at each automobile brand and is accordingly directed to a different webpage, 200, which, as shown in a representative screenshot in FIG. 2., containing the seller data retrieved from the data storage means 806 by the data retrieval means 808,

FIG. 2 illustrates a screen shot of a dealer's list webpage according to an embodiment of the present invention. The list of dealers, exemplified as 202a and 202b, presents the name of dealers who have a product catalogue matching to the end user's choice of automobile make. Display of such a dealers list is brought about by a retrieval of data by the data retrieval means 808 from the database associated with the webpage 100. Optionally, a brief description of products provided by the dealer or communication details such as mobile number, telephone, web information can be provided. The retrieval of data is through a retrieval means 808 associated with the webpage 100. The retrieval means is configured to look for the item searched in the database and accordingly return the item that matches the search criteria. Such retrieval is preferably random and thus the same search term at each time might not list the same result in exactly the same sequence as obtained in an earlier similar search. Each of the listed dealers has a separate homepage hosted on the website 100 and which can be accessed by an end user by clicking on the hyperlink that appears with the dealer names on the dealer's list webpage 200. A backend tool is available for dealers to customize their storefront/catalog. Thus, the dealers can set up their own discounts, policies, storecolors, banners etc.

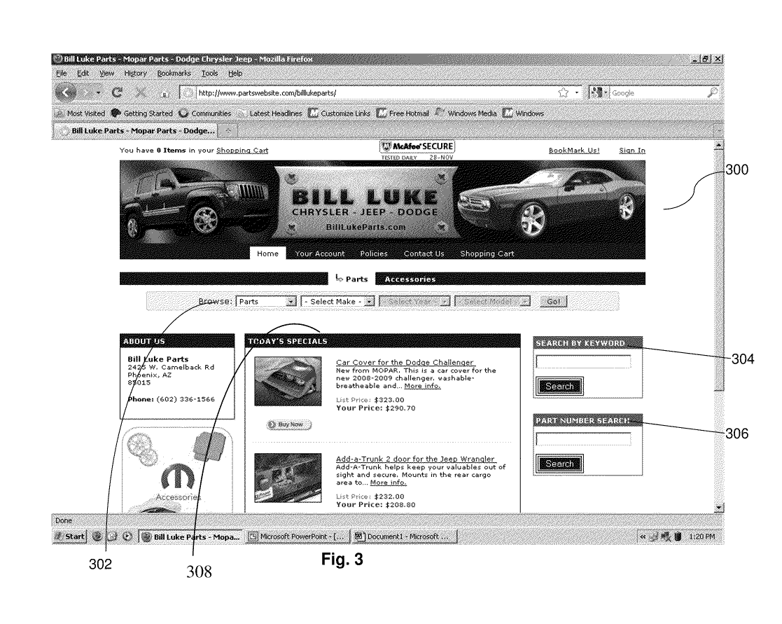

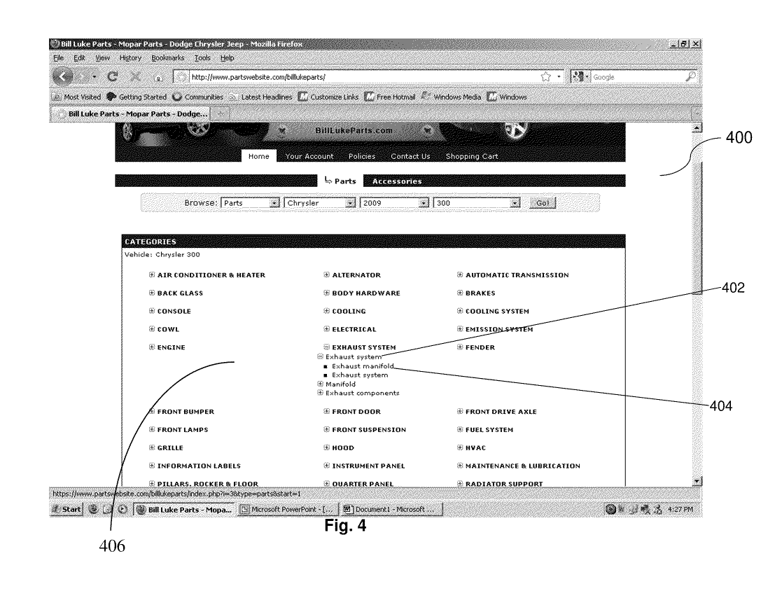

FIG. 3 illustrates a screen shot of a dealer's webpage according to an embodiment of the present invention. The webpage 300 comprise of information related to, but not limited to, a product catalogue representing the products on offer and their respective price detail, contact details of the dealer and other details which the dealer might find useful to put for the benefit of end user. To facilitate an easier browsing, in an embodiment of the invention, it is provided that the user enters his choice of ‘parts’ or ‘accessories’ that he is looking for. This feature is represented as icon ‘Browser’ present at location 302 at the webpage 300. The icon at 302 given an end user the option to select either ‘parts’ or ‘accessory’ depending on his exact query. Further, the end user selects, from a drop down menu at next tabs, his choice of automobile, make, year and model, so that a dedicated and efficient search is made which retrieves the most relevant results for the end user, thus saving the user much hassle and time in browsing through a complex data mesh to reach to his product(s) of choice. The webpage 300 further gives an end user an option to do a customized search by ‘keyword’, as shown in 304, or by ‘part number’, as shown in 306. This retrieves the relevant hit to the end user in a single click unlike the ‘Browse’ option where he is directed to a dedicated webpage with an option to select the broad ‘parts category’ first and then the specific part within the said broad parts category, as discussed in detail in FIG. 4

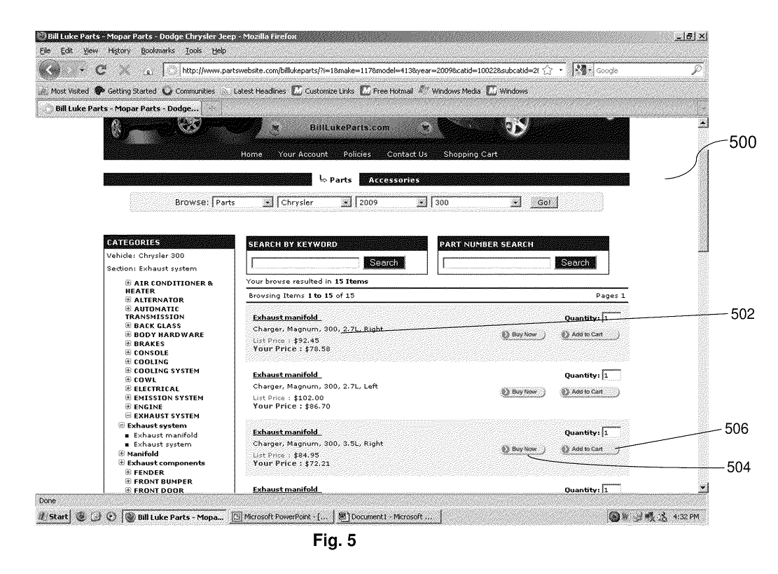

FIG. 4 illustrates a screen shot of a product catalogue webpage according to an embodiment of the present invention. The list of products catalogue is provided when a particular query is entered in the ‘Browse’ option. FIG. 4, thus, represents a case where the an end user is looking for an automobile ‘part’ for a Chrysler 300 model of 2009 make. The display, as shown at 400, is a list of various categories of parts available for that particular model and make. An end user can select his ‘parts’ of choice and depending on the ‘parts’, be further directed to a sub-list containing specific parts. An end user can then select the particular product of his choice and be directed to the specific product webpage as shown in FIG. 5

FIG. 5 illustrates a screen shot of a specific product webpage according to an embodiment of the present invention. The webpage 500 includes the information about the price and other product details, represented at 502, exemplified retrieved seller data for the particular selected product. It also provides an option to the end user of either buying the product at 504, or to add the product to the shopping cart, at 506, if he intends to do more shopping and wishes to be billed together.

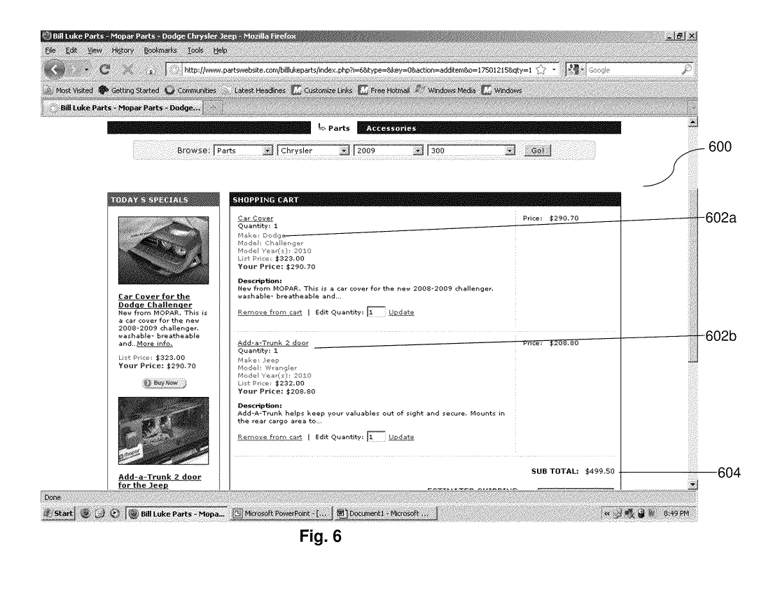

FIG. 6 illustrates a screen shot of a ‘shopping cart’ webpage according to an embodiment of the present invention. The shopping cart webpage 600 displays the list of products, 602a and 602b. The cumulative total price that the user incurs is displayed at 604. In an embodiment of the invention, the shopping cart has an order taking means associated with it wherein the said order taking means is configured to function over a communication network, preferably an internet communication network, to take and record the various products that the end user selects in course of his shopping at the webpage 100.

To successfully accomplish the payment procedure, a user has to create a ‘login’ account at the homepage 100. It not only secures his payment but also make it easier for him to manage and keep a track of the shipped product etc. In an embodiment of the invention, the payments are made through payment means associated with the webpage 100 and configured to function over a communication network, preferably an internet communication network. The payment is accomplished through secured payment gateways as is known in the art.

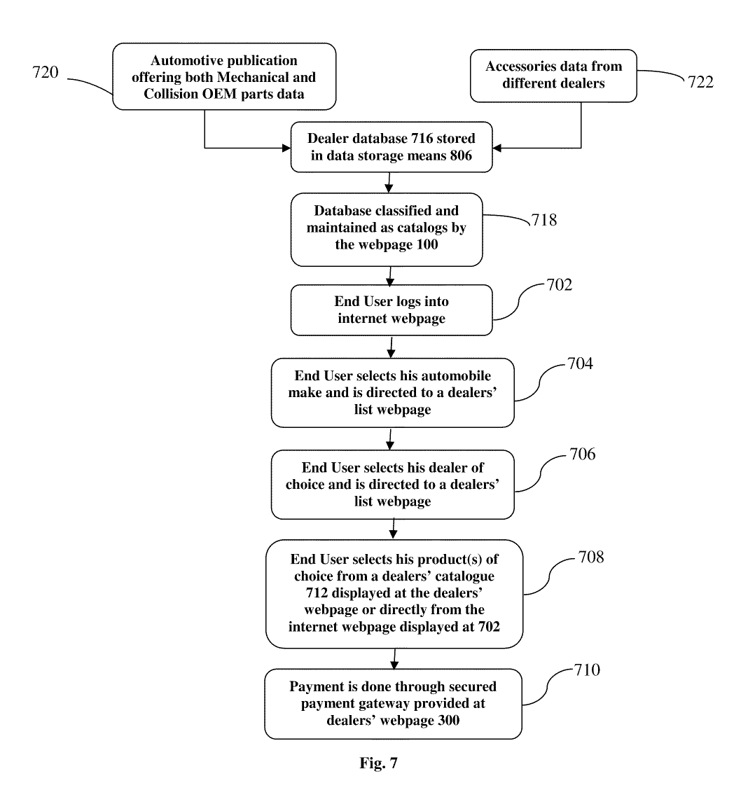

FIG. 7 illustrates an embodiment of the present invention. A dealer database 716 is created and is stored in the data storage means 806 configured to store parts data as obtained through an automotive publication offering both Mechanical and Collision OEM parts data 720. The accessories data 722, in contrast, comes from the respective dealers. The data so obtained from the respective sources are further classified and maintained as catalogs by the webpage 100. Further in FIG. 7, the different steps of accomplishing a shopping activity according to an embodiment of the present invention are shown. At block 702, an end user logs onto an internet webpage 100 to access multiple dealers product catalogue for a specific automobile make. The webpage 100 displays a list of automobile brands for which dealers' information is stored in the database of webpage 100.

At block 704, user selects his automobile make and is directed to a dealers' list webpage 200. The webpage 200 displays a list of dealers authorized to sell automobile parts and accessories pertaining to that particular make that the user has selected.

At block 706, user selects, from amongst the list of dealers as displayed at block 704, his dealer of choice and is then directed to said dealer's webpage 300 that contains retrieved seller data on an end user hosting means, exemplified as 308. The display at webpage 300 provides the user an option to choose a model, make and year of make of the automobile for which he is looking for parts and/or accessories and then accordingly, a relevant product catalogue is displayed, as is shown in FIG. 4.

At block 708, in an embodiment, user selects the product(s) which he intends to purchase from the dealers' catalogue, as illustrated at 406 & 712 in FIGS. 4 & 7 respectively, and add it to a ‘shopping cart’ option displayed at the webpage 300. The ‘shopping cart’, as displayed in FIG. 6, is an order taking means associated with the webpage 300 and the working of which is known in the art.

At block 710, purchase of the product(s) added to the shopping cart is made through secured payment gateway. The actual working of such payment gateways is through a payment means, the working of which is known in the art.

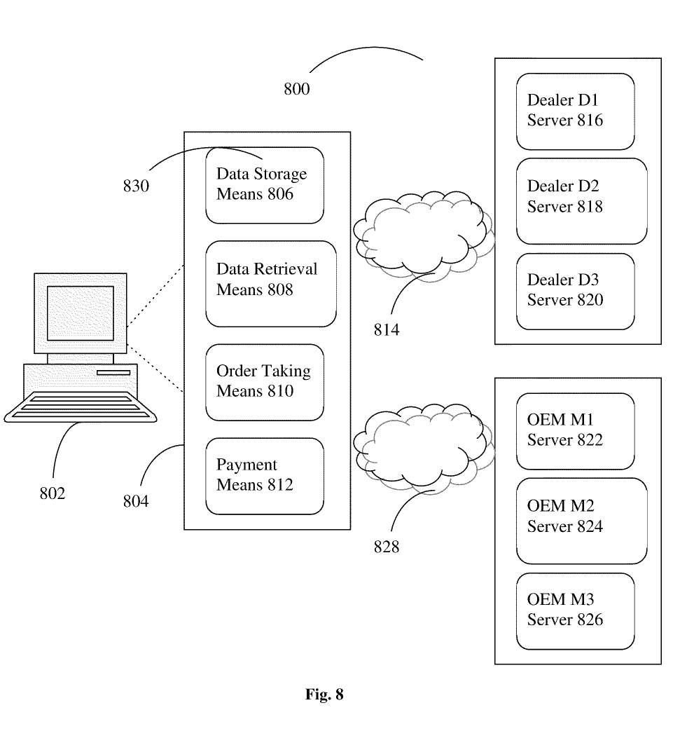

Referring to FIG. 8, a system 800 according to a preferred embodiment of the present invention can comprise an end-user hosting means 802, preferably in the form of a computer terminal which hosts the webpages 100, 200, 300, 400, 500 and 600. The server 804 of the webpages further comprise seller data 830 in a data storage means 806, a data retrieval means 808, a order taking means 810 and a payment means 812. The functional aspect of these system components have been discussed earlier. The server 804 is further connected to the each of the dealer servers system, 816, 818, 820, and the likes through a communication network 814. For instance, server 816 relates to server system of dealer D1, server 818 relates to server system of dealer D2, and server 820 relates to server system of dealer D3. In a preferred embodiment, the communication network 814 is an internet communication network. Similarly, server 804 is further connected to the each of the OEM servers system, 822, 824, 826, and the likes through a communication network 828. For instance, server 822 relates to server system of OEM M1, server 824 relates to server system of OEM M2, and server 826 relates to server system of OEM M3. In a preferred embodiment, the communication network 828 is an internet communication network. A distinct advantage provided by the embodiments of the present invention is that the webpage 100 enlists a detailed products list for each automobile make and model, irrespective of whether they are available in the current inventory of the respective dealer or not. This gives the dealers a chance to sell all of manufacturer's products, independent of whether his current inventory supports it or not, since, if the dealer doesn't have that product in his inventory, he can order it.

It will be understood that various modifications can be made to the embodiments of the present invention herein disclosed without departing from the spirit and scope thereof. Therefore, the above description should not be construed as limiting the invention but merely as exemplifications of preferred embodiments thereof. Those skilled in the art will envision other modifications within the scope and spirit of the present invention as defined by the claims appended hereto.

1. A web-based method for facilitating an e-commerce enabled transaction, said method comprising the steps of,
storing a plurality of a seller data in a database of a hosting webpage, wherein the database is created and stored in a data storage means configured to store parts data and accessories data;
retrieving one or more of the seller data from the database at the option of an end user and displaying the retrieved seller data on an end-user hosting means;
selecting one or more of the retrieved seller data;
ordering the selected seller data through a communication network connected with the end-user hosting means; and
paying for the selected seller data through payment means linked with the end-user hosting means.

2. The method as claimed in claim 1, wherein the end-user can select one or more of the parts or accessories for purchase from the seller data.

3. The method as claimed in claim 1, wherein the end-user hosting means comprises a computing means configured to function over a communication network.

4. The method as claimed in claim 1, wherein the retrieving of the seller data comprises selecting a hypermedia link.

5. (canceled)

6. The method as claimed in claim 1, wherein the ordering and payment means are associated with the end-user hosting means and configured to function over the communication network.

7. A web-based system for facilitating an e-commerce enabled transaction, said system comprising:
an end-user hosting means;
data storage and retrieval means associated with a hosting webpage for storing and retrieving atleast one of the seller data;
means for taking orders related to a selected data; and
means for accepting payment related to the selected data.
